(19) United States
(12) Patent Application Publication
(10) Pub. No.: US 2006/0147655 A1
(43) Pub. Date: Jul. 6, 2006

(54) Solid surface products

(75) Inventor: Dennis Schober, Newcastle, WA (US)

Correspondence Address: BLACK LOWE & GRAHAM, PLLC, 701 FIFTH AVENUE, SUITE 4800, SEATTLE, WA, 98104, US

(73) Assignee: Lumicor, Renton, WA (US)

(21) Appl. No.: 11/364,920

(22) Filed: Mar. 1, 2006

Related U.S. Application Data
(63) Continuation-in-part of application No. 10/762,206, filed on Jan. 21, 2004.
Application No. 10/762,206 is a division of application No. 10/106,833, filed on Mar. 25, 2002, now Pat. No. 6,743,327.
(60) Provisional application No. 60/307,898, filed on Jul. 25, 2001.

(51) Int. Cl. B44C 5/00

(52) U.S. Cl. 428/13; 428/480; 428/411.1

(57) ABSTRACT

A flat non-porous unitary solid surface product, and a method for the manufacture thereof, the product comprised of: (a) a flat non-porous unitary matrix made of polymethylmethacrylate, polyvinyl chloride, polycarbonate, or combinations thereof; and (b) a visible decorative object that is permanently fixated in the matrix, wherein the decorative object extends to least one edge of the matrix. Surfaces of the flat non-porous unitary matrix may be coated or treated to provide a dry-erase surface or projection screen.

### CROSS-REFERENCE TO RELATED APPLICATION

This application is a continuation-in-part of the application Ser. No. 10/762,206 filed on Jan. 21, 2004 and entitled, “Solid Surface Products,” the application being a divisional application of U.S. patent application Ser. No. 10/106,833, filed Mar. 25, 2002 and entitled, “Solid Surface Products,” which claims priority from U.S. Provisional Application No. 60/307,898 filed Jul. 25, 2001. Each of the Utility Patent applications and the Provisional Patent application is incorporated herein by reference.

### FIELD OF THE INVENTION

The present invention relates solid surface structures, and preferably to flat non-porous solid surface products comprised of: (1) a matrix made of polymethylmethacrylate, polyvinyl chloride, polycarbonate, or combinations thereof; and (2) one or more visible decorative objects that are permanently fixated in the matrix, and methods for manufacturing these products. These manufacturing methods do not involve using a mold or casting a liquid resin around the decorative object to be fixated. The solid surface products of the invention provide strikingly beautiful and unusual visual effects that are difficult to describe in words.

### BACKGROUND OF THE INVENTION

Solid surface products made of cured polymethylmethacrylate containing fine microscopic particles of inert inorganic fillers are known in the art. It is believed that all of the prior art polymethylmethacrylate solid surface products are made by using a mold and by casting therein a liquid acrylic resin which is then cured to form polymethylmethacrylate. For example, E. I. DuPont de Nemours and Company originated the solid surface category of products more than thirty years ago when it introduced the synthetic product sold under the trademark CORIAN which is believed to be a polymethylmethacrylate matrix containing large amounts of microscopic particles of inert inorganic fillers. It is believed that CORIAN is made by casting a liquid acrylic resin in a mold of some type and then curing the resin to form polymethylmethacrylate. CORIAN is usually an opaque product which mimics the decorative effect of marble. CORIAN is useful for kitchen countertops, kitchen sinks, bathroom lavatories, desktops, windowsills, and the like. Several patents owned by DuPont describe casting plastic simulated marble building products which are believed to be CORIAN. See Slocum U.S. Reissue Pat. No. Re 27,093, Duggins U.S. Pat. No. 3,488,246, Duggins et al. U.S. Pat. No. 3,642,975, Duggins U.S. Pat. No. 3,847,865, and Duggins et al. U.S. Pat. No. 4,107,135. In general terms, these DuPont patents describe cast products which are made of cured polymethylmethacrylate containing 30% to 80% by weight of microscopic particles (for example, particles having an average size of 7 microns) of inert inorganic fillers such as calcium carbonate, calcium sulfate, clay, silica, glass, calcium silicate, alumina, carbon black, titania, powdered metals, and alumina trihydrate.

Other synthetic solid surface products are sold by Avonite, Inc. under the trademark AVONITE which mimics the decorative effect of artificial stone. Risley U.S. Pat. No. 5,286,290 assigned to Avonite, Inc. describes dehydrating alumina trihydrate, rehydrating with a solution of dye, drying the solution to make colored alumina trihydrate, adding the colored alumina trihydrate to a resin matrix containing inert fillers, and cast to make a fire retardant solid decorative material having the appearance of artificial granite. The resin matrix may be ortho or iso polyesters, acrylics, or polycarbonates. The product may be in the form of a sheet or slab for kitchen countertops and decorative architectural surfaces or facades.

Eckart et al. U.S. Pat. No. 5,958,539 assigned to Eastman Chemical Company discloses a thermoplastic article having a fabric comprised of textile fibers embedded therein produced by applying heat and pressure to a laminate comprising, in order, (1) an upper sheet material, (2) a fabric comprised of textile fibers, and (3) a lower sheet material to produce a thermoplastic article having the fabric embedded therein. The upper and lower sheet materials are specifically made of PETG copolyester available from Eastman Chemical Company. PETG is the acronym for polyethylene terephthalate glycol.

A similar patent is Eckart et al. U.S. Pat. No. 5,998,028 assigned to Eastman Chemical Company which discloses a thermoplastic article having metallic wire, rod, and/or bar embedded therein produced by applying heat and pressure to a laminate comprising, in order, (1) an upper sheet material, (2) metallic wire, rods, or bars, and (3) a lower sheet material to produce a thermoplastic article having the metallic wire, rod, and/or bar embedded therein. As in Eckart et al. U.S. Pat. No. 5,958,539 above, the upper and lower sheet materials are specifically made of a PETG copolyester available from Eastman Chemical Company.

Another similar patent is Eckart et al. U.S. Pat. No. 6,025,069 assigned to Eastman Chemical Company which discloses a thermoplastic article having a high-relief, molded or embossed surface produced by contacting a laminate comprising a first or outer copolyester sheet material and a second or backing copolyester sheet material with heat and pressure using a heated element which simultaneously causes the material to be bonded and a high-relief, decorative appearance to be produced on at least one surface of the thermoplastic article. Also disclosed is an embossed or molded, bonded laminate comprising, in order, (1) a first or outer copolyester layer, (2) a second layer comprising a film which is colored or which bears an image or pattern, and (3) a third or backing copolyester layer, wherein the first and third layers are composed on the copolyester. As in Eckart et al. U.S. Pat. No. 5,958,539 and Eckart et al. U.S. Pat. No. 5,998,028 above, the copolyester layers are specifically made of a PETG copolyester available from Eastman Chemical Company.

Prior to the present invention, there existed a long-felt need for a dry process for making a solid surface product comprised of: (1) a matrix made of polymethylmethacrylate, polyvinyl chloride, polycarbonate, or combinations thereof; and (2) one or more visible decorative objects (objects that are visible to the unaided human eye) that are permanently fixated in the matrix. It was believed by knowledgeable people in the plastics industry that it was not possible to make such a solid surface product without using a mold and casting therein a liquid resin around the object to be fixated. It is believed that researchers who attempted to make such products using a dry process (that is, without using a mold and casting a liquid resin around the object to be fixated) produced products which contained defects such as air bubbles entrapped in the matrix, voids in the matrix, or cracks in the matrix.

Extensive research finally led to the present invention which allows an object to be fixated in a unitary matrix made of polymethylmethacrylate, polyvinyl chloride, polycarbonate, or combinations thereof, without using a mold and casting therein a liquid resin around the object. In addition, the present invention provides aesthetically-pleasing products which are free of defects of the type referred to above.

### SUMMARY OF THE INVENTION

One example of the invention is a non-porous solid surface structure comprised of: (a) a flat non-porous unitary thermoplastic polymeric matrix made of polymethylmethacrylate, polyvinyl chloride, polycarbonate, or combinations thereof; and (b) a visible decorative object that is permanently fixated in the matrix, wherein the decorative object extends to least one edge of the matrix.

Other examples of the invention include a method for manufacturing non-porous solid surface structure including the steps of: (a) providing a first non-porous thermoplastic polymeric sheet made of polymethylmethacrylate, polyvinyl chloride, or polycarbonate; (b) placing a decorative object on the first sheet of polymeric material wherein the decorative object extends beyond at least one edge of the first sheet of polymeric material; (c) placing a second non-porous unitary thermoplastic polymeric sheet of made of polymethylmethacrylate, polyvinyl chloride, or polycarbonate on top of the decorative object wherein the decorative object also extends beyond at least the corresponding edge of the second sheet of polymeric material, whereby a lay-up sandwich is formed comprised of the first sheet of polymeric material, the decorative object which extends beyond at least one edge of both of the sheets of polymeric material, and the second sheet of polymeric material; (d) loading the lay-up sandwich into a press; (e) applying a predetermined amount of heat and pressure to the lay-up sandwich for a predetermined period of time; (f) opening the press to allow air and gases to escape from the lay-up sandwich; (g) closing the press and applying a predetermined amount of heat and pressure to the lay-up sandwich for a predetermined period of time whereby the first and second polymeric material sheets melt together in the lay-up sandwich to provide a unitary product; and, (h) allowing the product to cool while maintaining the pressure at a predetermined level until the product reaches a predetermined temperature at which point the press is opened and the product is removed from the press.

### BRIEF DESCRIPTION OF THE DRAWINGS

FIG. 1 is a pictorial or three-dimensional view of one embodiment of the invention illustrating a solid surface product having a matrix made of polymethylmethacrylate, polyvinyl chloride, polycarbonate, or combinations thereof, and decorative objects that are permanently fixated in the matrix. In this example, the fixated objects consist of dried long-stem grass.

FIG. 2 is an exploded pictorial view illustrating the starting materials employed in making the product shown in FIG. 1. In this example, the starting materials are an upper sheet made of polymethylmethacrylate, polyvinyl chloride, or polycarbonate material, the objects to be fixated consist of dried long-stem grass, and a lower sheet made of polymethylmethacrylate, polyvinyl chloride, or polycarbonate material.

FIG. 3 is a pictorial view illustrating the product shown in FIG. 1 in a finished stage of production before trimming.

FIG. 4 is an exploded pictorial view illustrating the starting materials employed in making a second embodiment of the invention. In this example, the starting materials are an upper sheet of polymethylmethacrylate, polyvinyl chloride, or polycarbonate material, an intermediate sheet of polymethylmethacrylate, polyvinyl chloride, or polycarbonate material that has been textured on both surfaces, and a lower sheet of polymethylmethacrylate, polyvinyl chloride, or polycarbonate material.

FIG. 5 is a vertical cross-sectional view of the product of FIG. 1 when viewed in the direction of the arrows 5-5 in FIG. 1. The phantom line in FIG. 5 indicates the location where the inner surfaces of two sheets of polymeric material interfaced before they melted together in the manufacturing process.

FIG. 6 is a partial cross sectional view of an alternative embodiment of the product having a contoured shape and an outer operative layer.

FIG. 7 is a partial cross sectional view of an alternative embodiment of the product having a contoured shape and an operative structure captured within the sheets of polymeric material.

FIG. 8 is a partial cross sectional view of an embodiment of the product suitable for use as bullet-resistant glass.

FIGS. 9A and 9B are side cutaway views of a sink formed of laminate.

FIGS. 10A and 10B are perspective views illustrating preformed layers forming a sink and molds for forming a sink.

FIGS. 11A-11B are perspective views illustrating layers forming a sink and molds for forming a sink.

FIG. 12 is a perspective view of floor tiles formed having decorative objects embedded therein.

### DETAILED DESCRIPTION OF THE PREFERRED EMBODIMENTS

A preferred form of the invention provides non-porous unitary solid surface products and methods for manufacturing the same. By the term “unitary,” it is meant that the products are physically an undivided single piece, and therefore they are not a laminate structure consisting of separate layers that can be separated or delaminated. It should be understood that some products of the invention might visually appear (to the unaided human eye) to be a laminate of separate layers which maintain their integrity, but this visual appearance is not correct. The layers of polymeric starting material have in fact melted together and have become an undivided single piece. From the standpoint of aesthetically-pleasing visual appearance, line drawings and words are not capable of describing the strikingly beautiful and unusual visual effects provided by the solid surface products of the invention. The inventive solid surface products may be employed to make countertops, sinks, lavatories, desktops, table tops, chairs, windowsill, and the like.

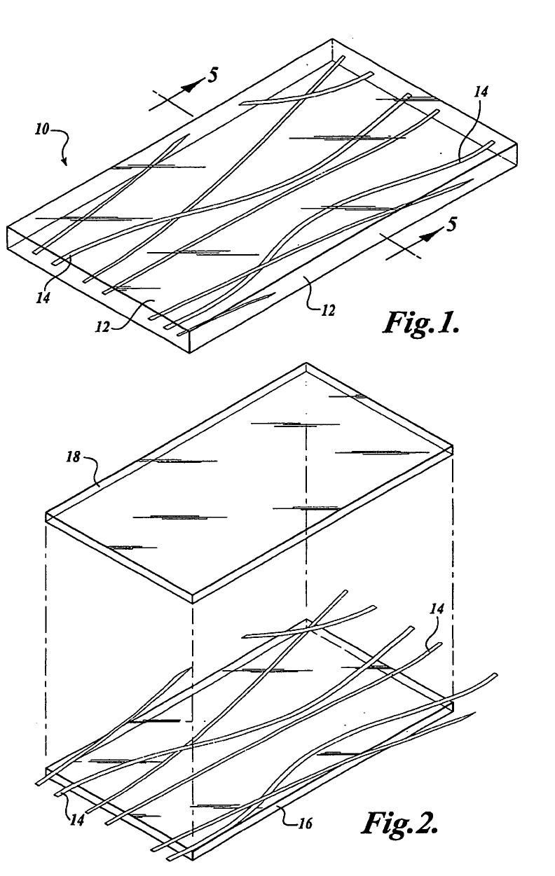

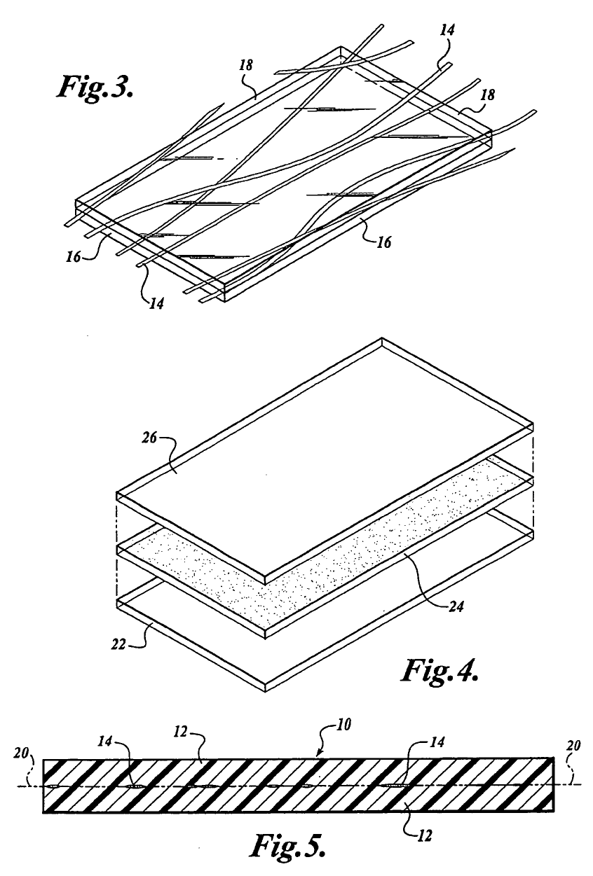

The first embodiment of the invention, illustrated by the product in FIG. 1, is a flat non-porous unitary polymeric solid surface structure 10 comprised of a matrix 12 made of clear polymethylmethacrylate, polyvinyl chloride, polycarbonate, or combinations thereof, and one or more visible decorative objects 14 (that is, objects that are visible to the unaided human eye) that are permanently fixated in the matrix 12. In the example illustrated by FIG. 1, the fixated decorative objects 14 consist of dried long-stem grass. As shown in FIG. 1, the fixated decorative objects 14 appear to float in the transparent matrix 12. The outer surfaces of the solid surface structure may have any desired finish, such matte, semi-gloss, or high gloss. The flat structure 10 may be subjected to conventional thermoforming/shaping processes if a non-flat shape is desired.

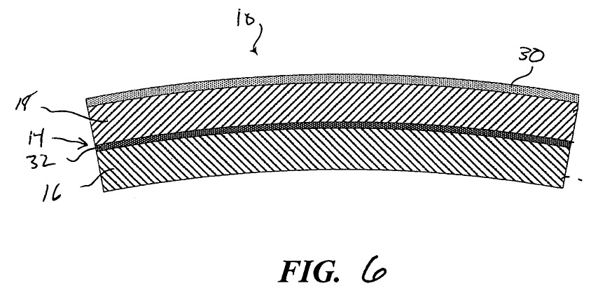

FIG. 5 is a vertical cross-sectional view of product 10 viewed in the direction of the arrows 5-5 shown in FIG. 1. The phantom line 20 in FIG. 5 indicates the location where the inner surfaces of polymeric sheets 16 and 18 interfaced before they melted together in the manufacturing process (as will be described below).

### The Basic Lay-Up Sandwich

The unitary solid surface structures 10 constructed according to the first embodiment of the present invention contain fixated decorative objects 14. The decorative objects 14 can be made of various materials as will be described below. FIG. 2 illustrates how a solid surface structure of this invention is made from a basic lay-up sandwich consisting of the following starting materials: (1) a bottom sheet 16 made of polymethylmethacrylate, polyvinyl chloride, or polycarbonate material; (2) one or more layers of a decorative material 14 (the object to be fixated) which also functions as a breather layer for air and gases to escape during the manufacturing process; and, (3) a top sheet made of polymethylmethacrylate, polyvinyl chloride, or polycarbonate material. As shown in FIG. 2, during lay up the decorative material 14 preferably extends beyond the edges of polymeric sheets 16 and 18. As mentioned above, decorative material 14 provides an escape path for air, water vapor, and gases generated during the pressing operation. Prior to the pressing operation, the decorative material 14 that extends beyond the edges of polymeric sheets 16 and 18 is pulled taunt and taped to a caul plate (as will be described below).

Variations on this basic lay-up sandwich may include more than two layers of polymeric material and multiple layers of decorative materials, alternating one and then the other. For example, the basic lay-up sandwich may consist of: (1) a top sheet of polymeric material; (2) a first layer of decorative material; (3) an intermediate sheet of polymeric material; (4) a second layer of a decorative material; and, (5) a bottom sheet of polymeric material.

The thickness of product 10 may range from about 0.030 inch (0.7937 mm) to 2.0 inches (50.80 mm). However, thicker and thinner gauges are possible based on the press capabilities and starting material availability.

### Polymethylmethacrylate, Polyvinyl Chloride, and Polycarbonate Starting Materials

The non-porous polymeric sheets 16 and 18 may be clear (transparent), colored, textured (on one or both faces), frosted, translucent, opaque, and they may also contain fire-retardant additives and performance additives.

The polymeric sheets 16 and 18 may vary in thickness from about 0.004 inch (0.100 mm) to 1.0 inch (25.4 mm). Also, the polymeric sheets 16 and 18 in the basic lay-up sandwich may vary in thickness from each other.

Polymethylmethacrylate sheet material can be manufactured by casting or by extrusion. The preferred polymethylmethacrylate sheet material is made by extrusion and has more consistent gauge. Polymethylmethacrylate sheet material made by casting has inconsistent gauge (hills and valleys) which will cause problems with air and gas entrapment and also gloss/texture problems on the surface of the product caused by pressure variations. In one embodiment of the invention, the decorative materials 14 are interleaved with the polymeric sheets 16 and 18 by co-extruding the polymeric sheets 16 and 18 on opposing sides of a suitably fed sheet of decorative material 14. In this process, the decorative material 14, typically any of fabric, paper or plastic film is roll laminated between the polymeric sheets 16 and 18. An embossing roller can optionally be used to control texture and gloss level of the sheet during extrusion.

The preferred polymethylmethacrylate sheet material has the following properties:

| | ASTM Test | | |
|---|---|---|---|
| | Method | Units | Value |
| Physical Properties | | | |
| Specific Gravity | D-792 | | 1.19 |
| Optical Refractive Index | D-542 | | 1.49 |
| Light Transmittance Index | D-1003 | % | 92 |
| (sample thickness | | | |
| 0.100 inch) | | | |
| Total | | % | 2 |
| Haze | | | |
| Sound Transmission | E90-70 | | 27 |
| (0.125 inch Thickness) | E 413 | | |
| Water Absorption | D-570 | % | 0.4 |
| | | by weight | |
| Shrinkage | D-702 | % | <5% |
| | | shrinkage | |
| Mechanical Porperties | | | |
| Tensile Strength, | D-638 | psi | 10,100 |
| Maximum | | | |
| Tensile Elongation, | | % | 5.1 |
| Maximum | | | |
| Modulus of Elasticity | | psi | 431,000 |
| Flexural Strength, | D-790 | psi | 14,600 |
| Maximum | | | |
| Izod Molded Notch | D-256-56 | Ft lbs/inch | 0.4 |
| ½ inch × 2½ inch × ¼ inch bar | | of notch | |
| at 73° F. | | | |
| Izod Milled Notch | | Ft lbs/inch | 0.28 |
| ½ inch × 2½ inch × ¼ inch bar | | of notch | |
| at 73° F. | | | |
| Tensile Impact Strength | D-1822 | Ft lbs/in² | 20 |
| Abrasion Resistance | D-1044 | | |
| 0 cycles | | Haze % | 2 |
| 10 cycles | | Haze % | 15 |
| 50 cycles | | Haze % | 30 |
| 200 cycles | | Haze % | 50 |
| Rockwell Hardness | D-785 | | M-93 |
| (sample thickness 0.25 inch) | | | |
| Thermal Properties | | | |
| Maximum | | ° F. | 170-190 |
| Recommended | | | |
| Continuous Service | | | |
| Temperature | | | |
| Softening Temperature | | ° F. | 210-220 |
| Melting Temperature | | ° F. | 300-315 |
| Deflection Temperature | D-648 | | |
| Load, Unannealed | | | |
| 3.6° F./minute, 264 psi | | ° F. | 190 |
| 3.6° F./minute, 66 psi | | ° F. | 205 |
| Coefficient of Thermal | D-696 | Ins/in/° F. × 10° | |
| Expansion | | | |
| −40° F. | | | 2.7 |
| −20° F. | | | 2.9 |
| 0° F. | | | 3.1 |
| 20° F. | | | 3.2 |
| 40° F. | | | 3.4 |
| 60° F. | | | 3.6 |
| 80° F. | | | 3.9 |
| 100° F. | | | 4.3 |
| Thermal Conductivity | C-177 | BTU | 0.9 |
| | | (Hr) (Ft²) (° F./in) | |
| Flammability | D-635 | Ins/minute | |
| (Burning Rate) | | 0.060 inch | 1.019 |
| | | 0.236 inch | 0.318 |
| Smoke Density Rating | D-2843-77 | % | |
| | | 0.236 inch | 0.36 |
| Self-Ignition Temp | D-1929 | ° F. | |
| | | 0.236 inch | 833 |
| Flame Spread Index/ | E-84-86 | 0.375 inch | 110 |
| Smoke Developed Index | | 0.236 inch | 115 |
| Chemical Properties | | | |
| Resistance to Stress- | ARTC | | |
| Critical Crazing stress to: | modification of | | |
| | MIL-P-6997 | | |
| Isopropyl Alcohol | | psi | 900 |
| Lacquer Thinner | | psi | 500 |
| Toluene | | psi | 1,300 |
| Solvesso 100 | | psi | 1,600 |

The preferred polyvinyl chloride sheet material has the following properties and is sold under the trademark INTEDUR TYPE II by World-Pak Corporation/Inteplast Corporation, Livingston, N.J.:

| | | | |
|---|---|---|---|
| Properties | Test Method | Units | Value |

PHYSICAL

| | | | |
|---|---|---|---|
| Thickness | ASTM D1505 | in. | 1/16 inch˜½ inch |
| Density | ASTM D792 | g/cm³ | 1.33˜1.41 |

MECHANICAL

| | | | |
|---|---|---|---|
| Tensile | ASTM D638 | psi | 6,000˜8,000 |
| Strength @ Yield | | | |
| Elongation @ Break | ASTM D638 | % | 30˜70 |
| Flexural Modulus | ASTM D790 | psi | 300,000-400,000 |
| Flexural | ASTM D790 | psi | 6,000˜10,000 |
| Strength @ Yield | | | |
| Izod Impact Strength | ASTM D256 | ft-lbs./in. | 5˜17 |
| (Notched) | | | |
| Shore Hardness | ASTM D2240 | D | 73˜81 |
| (D scale) | | | |

THERMAL

| | | | |
|---|---|---|---|
| Heat Deflection | ASTM D648 | ° F. | 145-155 |
| Temperature | | | |
| Vertical Burn Test | UL 94 | — | V-O |

The preferred polycarbonate sheet material has the following properties and is sold under the trademark LEXAN 9600 by General Electric Company, Pittsfield, Mass.:

| Property | Test Method | Units | Value |
|---|---|---|---|
| PHYSICAL | | | |
| Specific Gravity | ASTM D792 | — | 1.25 |
| Water Absorption, Equilibrium, 24 Hrs | ASTM D570 | % | 0.20 |
| Light Transmission (avg.), 0.125 inch | ASTM D1003 | % | 85 |
| thickness | | | |
| MECHANICAL | | | |
| Tensile Strength | ASTM D638 | psi | |
| @ Yield | | | 9,500 |
| Ultimate | | | 9,000 |
| Elongation | ASTM D638 | % | 95 |
| Tensile Modulus | ASTM D638 | psi | 235,000 |
| Flexural Strength | ASTM D790 | psi | 13,500 |
| Flexural Modulus | ASTM D790 | psi | 370,000 |
| Compressive Strength | ASTM D695 | psi | 12,500 |
| Dynatup Impact Strength, ½ inch dia. | ASTM D3783 | ft-lbs | 50 |
| dart, (gauge dependant), @ 73° F. | | | |
| Gardner Impact Strength, round tup | ASTM D3029 | in-lbs. | >320 |
| (gauge dependant), @ 73° F. | | | |
| Izod Impact Strength (gauge | ASTM D256A | ft-lbs./in. | |
| dependant) | | | |
| Notched @ 73° F. | | | 2.4 |
| Unnotched @ 73° F. | | | NB |
| THERMAL | | | |
| Coefficient of Thermal Expansion | ASTM D696 | in./in./° F. | 3.75 × 10⁻⁵ |
| Heat Deflection Temperature | ASTM D648 | ° F. | 280 |
| @ 264 psi | | | |
| FLAMMABILITY | | | |
| UL Flammability | UL 94 | — | V-0 (90 mils and |
| | | | above) |
| | | | V-2 (34-89 mils) |
| FAA Flammability @ 40 to 125 mils | FAR 25.853 | — | Passes A & B |
| ATS 1000 @ 40 to 125 mils | — | — | Pass |

### Materials for Decorative Object to be Fixed

The material 14 to be fixated in the polymeric matrix 12 may be made of textile fabric, paper, plastic film, plastic sheet, metallic wire, rod, mesh, bar, wood veneer, and various dried natural materials (such as the long-stem grass illustrated in FIG. 1), tree bark, plant leaves, petals, and twigs). The material should be allowed to dry to avoid giving off water vapor or steam during the manufacturing process.

The material 14 may be one or more layers of a textile fabric made of various fibers. Textile fabrics can impart beautiful and unusual visual effects to the product, such as an iridescent effect or a moiré effect. Non-limiting examples of suitable textile fabrics are: synthetic, semi-synthetic, naturally occurring and polymeric, including for example, rayon, polyester, nylon, synthetic polyamides (such as nylon 66 and nylon 6), acrylic, modacrylic, cellulose acetate, cotton, wool, silk and fiberglass. The fabric may be woven, knitted, spun-bonded, or prepared by other well-known processes in the textile trade. The fabric may be printed, coated, dyed, sublimated or decorated by other techniques known within the textile trade. Fabrics with loose weaves and have as open area of 0.005 inch or greater between yarns/threads are best. Fabrics with rough and porous surfaces are also preferred over smooth surfaces. Tightly woven fabrics with smooth surfaces will not function in the thermal melting process because they prevent resin transfer through the material. Natural fibers are preferred due to their porosity. The melted resin saturates such fibers more readily. The textile fabric may vary in thickness from about 0.00045 inch (0.0114 mm) to 0.25 inch (6.35 mm).

As mentioned above, the material 14 to be fixated in the matrix 12 may also be made of wood veneer, paper, dried plant fibers and parts. Non-limiting examples are: cellulose, cotton, linen, pulp, rag, dried plant materials and fibers including long-stem grass, leaves, petals, bark and twigs from reed, bamboo, papyrus, banana, mulberry, and wicker. For these types of material, the thickness of the layer may be from about 0.00045 inch (0.0114 mm) to 0.25 inch (6.35 mm).

The material 14 to be fixated in the polymeric matrix 12 may also be made of dry metal. Non-limiting examples are: copper, bronze, brass, steel, stainless steel, iron, nickel, and aluminum. Variety of shapes including: rod, mesh, sheet, perforated sheet, foil, strips, shavings, woven, and cable. The metal may be decorated such as etched, anodized, sanded, brushed, stained, painted, printed, chemically treated, galvanized, corroded, aged, polished, and plated. For these types of material, the thickness of the layer may be from about 0.00045 inch (0.0114 mm) to 1.0 inch (25.4 mm).

The material 14 to be fixated in the matrix 12 may also be a plastic sheet or film. Non-limiting examples are: polymethylmethacrylate, polycarbonate, polyvinyl chloride, PETG copolyester, polyethylene, polypropylene, polyester, polyvinylidinefluoride (PVDF) (sold under the trademark KYNAR), polyvinylfluoride (PVF) (sold under the trademark TEDLAR), and polyurethane. For these types of material, the thickness of the layer may be from about 0.00045 inch (0.0114 mm) to 1.0 inch (25.4 mm). Nor is it necessary that the decorative material 18 be a sheet. Plastic materials suitable for inclusion can be in any of cast, extruded, coated, calendared, or formed configurations. The plastic materials can include variations in qualities of the plastic such as different colors, finishes varying in texture, qualities of light transmission such as frosting, translucence, and opacity. Decorative qualities of the resulting lay up matrix 10a may optionally be enhanced by the eye-catching features included in the decorative materials 18. Such features may be distinctively colored, printed, metallized, sublimated, dyed, textured, painted, embossed, or foil stamped.

Decorative materials 14 may also include gems or glass products such as glass sheets, beads, or fragments. Where glass materials are used as the decorative material 14 the decorative material 14 may optionally include clear float glass, annealed or tempered glass. Surfaces of the glass may be suitably textured, tinted, frosted, etched, stained, colored, or sandblasted. Typically, thicknesses ranging from 0.090 inch (2.5 mm) to 1 inch (25.4 mm) are suitable for uniform heating across the polymeric sheets 16, 18, inasmuch as the glass introduces a significant variance in a specific heat of either of the polymeric sheets 16, 18. Furthermore, heating and cooling times may be adjusted to achieve suitable fusion of the polymeric sheets 16, 18.

### Manufacturing Process

The invention also includes a preferred method for manufacturing the solid surface structure 10. These manufacturing methods do not involve using a mold and casting a liquid resin around the object to be fixated.

In order to produce products 10 which are free of defects (such as air or gas bubbles entrapped in the matrix, voids in the matrix, or cracks in the matrix), to the preferred embodiment incorporates the following operating parameters. These process parameters work well with most paper and fabric decorative materials.

First, the basic lay-up sandwich must be processed in a heated press that can apply the required heat and pressure to melt the polymeric sheets 16 and 18 together and thereby create the matrix 12 that fixates the one or more decorative objects 14 within the matrix. Most preferred is a steam heated multiple opening press. Suitable presses include a multiple opening lamination press (MOP), autoclave, vacuum bag laminator, vacuforming machine, or other suitable machine that can apply the required heat and pressure to fuse the materials together

Second, when using the preferred polymeric sheets described above, the press should be preheated to a temperature of about 280° F. Then the lay-up sandwich is loaded into the press. The press is then closed against the lay-up sandwich at a pressure of about 40 pounds per square inch (psi). The press temperature is then ramped up until the lay-up sandwich reaches a temperature of about 290° F.-310° F. while maintaining the pressure at about 40 psi. This temperature works well for polymethylmethacrylate and polyvinyl chloride. Polycarbonate requires a higher temperature of about 350° F.-375° F.

Third, at this point the press is opened and all pressure is removed from the lay-up sandwich. This step is referred to as “bumping” the press. In some instances this step may be important in order to allow the heated air, water vapor, and gases to escape from between the polymeric sheets 16 and 18 in the lay-up sandwich so that bubbles or voids are not entrapped in the matrix 12. It should be understood, however, that this step is not essential to the invention.

Fourth, the press is then closed against the lay-up sandwich and the pressure is ramped up to about 160 psi. The press temperature is then ramped up until the materials in the lay-up sandwich reach about 290° F.-310° F. while maintaining the pressure at about 160 psi. Again, this temperature works well for polymethylmethacrylate and polyvinyl chloride, but polycarbonate requires a higher temperature of 350° F.-375° F. This pressure and temperature is then held for about 1 to 6 minutes depending on the thickness of the lay-up sandwich to allow the polymeric sheets 16 and 18 to melt together in the lay-up sandwich.

Fifth, the heat is turned off and the product is allowed to gradually cool while maintaining the pressure at about 160 psi until the product reaches a temperature of about 100° F. at which point the press is opened and the product (which needs some trimming) is removed from the press. If needed, a coolant may be circulated through the platens to cool the press. This step of gradually cooling the product is important because the product is being annealed, thereby removing the internal strains resulting from the previous operations. This prevents the polymeric matrix 12 from developing cracks, warping, or excessive shrinking. In the case of decorative objects 14 formed of glass and other highly heat-conductive materials, the head capacity and thermal conductivity of the decorative objects 14 and the polymeric sheets 16 and 18 may be very different. Accordingly, slower cooling times for such objects 14 may be used to avoid localized cold and hot areas which may cause internal stress and lead to the defects mentioned above.

Prior to full-scale production, the compatibility between specific decorative materials and the polymeric sheets should be evaluated. Some decorative materials can degrade under heat and pressure resulting in discoloration, color bleed, and separation.

During the pressing process, the outer surface of the polymeric sheets can optionally be deeply embossed or also textured using coated release papers or release films. A variety of suitable textured release papers made from polyester, polyvinyl fluoride and perfluoroalkoxy tetraflouroethylene are available from the S.D. Warren Company, Westbrook, Me. A variety of release films are available from the DuPont Company, Wilmington, Del. The release papers and release films have specific textures and gloss levels that are transferred onto the polymeric sheets during the pressing/heating operation. The release papers and release films also separate the polymeric sheets from the caul plate (described in Example 1 below) and thereby they prevent the polymeric sheets from sticking to the caul plate.

### Refinishing

One of the advantages of the solid surface structures of the invention is that if they become scratched or marred, they are capable of being restored and refinished. This is particularly important for applications such as table tops and countertops. Refinishing may be accomplished for matte, semi-gloss, and high gloss finishes. The preferred process for refinishing uses an orbital disc sanding machine and film abrasives sold under the trademark TRIZACT and disc sanding pads sold under the trademark HOOKIT II, both products of Minnesota Mining and Manufacturing Co., St. Paul, Minn. The process involves sanding out the defects in the surface and then polishing.

### Optional Features

During the pressing/heating operation, specialty films can also be applied one or both of the polymeric sheets to enhance the abrasion resistance, chemical resistance, and ultraviolet resistance of the final product. These specialty films may be made of various materials including polyester, polyvinylfluoride (PVF), ethylene trifluoroethylene (ETFE), fluorinated ethylenepropylene (FEP), polyvinylidenefluoride (PVDF), and chlorotrifluoroethylene (CTFE).

These specialty films can be on the top and/or bottom of the final product. Typically, these films have a higher melt point than polymethylmethacrylate and therefore require the use of a heat-activated adhesive coating, which is applied to the film prior to the pressing/heating operation. Generally, the specialty film has a thickness of 0.004 inch (0.100 mm) to 0.020 inch (0.500 mm).

### EXAMPLE 1

In this example, the basic lay-up sandwich consists of three layers of the following starting materials: (1) a bottom sheet of the preferred polymethylmethacrylate material that is 0.060 inch thick, 48 inches wide, and 96 inches long; (2) a decorative textile fabric that is 58 inches wide and 102 inches long; and (3) a top sheet of the preferred polymethylmethacrylate that is 0.060 inch thick, 48 inches wide, and 96 inches long.

The final lay-up book is made as follows. A textured sheet of release paper that is 60 inches wide and 100 inches long is placed on a 0.060 inch thick aluminum caul plate and taped to the caul plate. The basic lay-up sandwich (described in the paragraph above) is placed on top of the textured sheet of release paper. The textured sheet of release paper will impart an aesthetically-pleasing texture to the outer surface of the bottom sheet of polymethylmethacrylate. The decorative textile fabric extending beyond the edges of polymethylmethacrylate sheets is pulled taunt and taped to the caul plate. Another sheet of textured release paper that is 60 inches wide and 100 inches long is placed on top of the basic lay-up sandwich. This textured sheet of release paper will impart an aesthetically-pleasing texture to the outer surface of the top sheet of polymethylmethacrylate. Another caul plate is placed on top of the upper sheet of textured release paper and the upper textured sheet of release paper is taped to the caul plate. Thermocouples are attached to the lay-up sandwich so that the temperature of the sandwich can be accurately measured.

Four plies of canvas are placed below the bottom caul plate and above the top caul plate to evenly distribute the pressure and heat during the pressing/heating operation. The book is placed on a 0.125 inch thick aluminum sheet loader pan to facilitate loading and unloading of the book into the press. In some embodiments, NOMEX felt or silicone sheets, rather than canvas, are used, such as 0.125 inch 45 durometer silicone sheets will also work with thermoplastic fusion but canvas padding has proven more economical. In some embodiments, textured or etched glass is used as the top and bottom layers of the laminate, in which case silicone plates may discourage breakage.

The press is preheated to a temperature of about 280° F. Then the final lay-up book is loaded into the press. The press is closed against the book at a pressure of about 40 psi. The press temperature is then ramped up until the lay-up sandwich reaches a temperature of about 290° F.-310° F. while maintaining the pressure at about 40 psi. The press is opened and all pressure is removed from the book. The press is closed against the book and the pressure is ramped up to about 160 psi. The press temperature is ramped up until the materials in the lay-up sandwich reach a temperature of about 290° F.-310° F. while maintaining the pressure at about 160 psi. This pressure and temperature is then held for about 1 to 6 minutes depending on the thickness of the lay-up sandwich to allow the polymethylmethacrylate sheets to melt together in the lay-up sandwich to provide a unitary product.

The heat is then turned off and the product is allowed to gradually cool while maintaining the pressure at about 160 psi until the product reaches a temperature of about 100° F. at which point the press is opened and the product (which may need some trimming) is removed from the press. Alternatively, the product may be removed from the press after heating and moved into a second press having a lower temperature than the first press. The second press may then continue to apply pressure, such as at 160 psi until the product is removed. The second press may be maintained at a lower temperature than the first press by means of chilling or simply by refraining from heating the second press. Use of a second, colder press may facilitate rapid manufacturing times inasmuch as heat transfer rates are increased.

Example 1 can also be performed using polyvinyl chloride or polycarbonate, but polycarbonate requires the higher temperature of 350° F.-375° F. Example 1 can also be performed using a combination of polymethylmethacrylate, polyvinyl chloride, or polycarbonate. There are benefits in combining the properties of two thermoplastics. For example, by combining polyvinyl chloride and polymethylmethacrylate, the polyvinyl chloride will improve the flammability and chemical resistance of the polymethylmethacrylate, and the polymethylmethacrylate will improve the clarity, ultraviolet resistance, and abrasion resistance of the polyvinyl chloride. The thermoplastics need to be formulated to have similar processing temperatures to work in the press process.

### EXAMPLE 2

In this example, the thickness of the product is 0.25 inch or greater. When fabricating products in a thickness of 0.25 inch or greater employing delicate decorative papers, fabrics, or organic materials, a first stage is necessary to encapsulate the decorative material within two thin sheets of 0.060 inch polymethylmethacrylate to prevent tearing of the decorative material caused by movement of the polymethylmethacrylate during pressing. The thinner sheets of polymethylmethacrylate will hold the decorative material in place with minimal movement during stage two. The two-stage process enables products to be made in thicker gauges with less “melt out.” Thus, maximum thickness is preserved. The goal is to transfer heat to the lay-up sandwich to melt the polymethylmethacrylate sheets together using the least amount of heat, pressure, and time.

In stage 1, a 0.12 inch intermediate product with 0.005 inch relief texture is made encapsulating the delicate decorative material. First, an intermediate lay-up book is made consisting of the following sequence from top to bottom: (1) four plies of canvas padding; caul plate; (2) textured release paper or plate providing 0.005 inch relief; (3) 0.060 inch clear polymethylmethacrylate sheet (size 48 inches by 96 inches); (4) a layer of the delicate decorative material; (5) 0.060 inch clear polymethylmethacrylate sheet (size 48 inches by 96 inches); (6) textured release paper or plate providing 0.005 inch relief; (7) caul plate; and, (8) four plies of canvas padding.

The press is heated to about 280° F., the intermediate lay-up book is placed in the press, and the press is closed. The pressure is brought to 40 psi. When the materials in the lay-up reach 290° F., the pressure is increased to 160 psi and held for 1 minute. The intermediate product is then gradually cooled to 100° F.

In stage 2, the final lay-up book is made consisting of the following sequence from top to bottom: four plies of canvas padding; caul plate; textured release paper or plate; 0.060 inch clear polymethylmethacrylate sheet (size 48 inches by 96 inches); 0.12 inch textured intermediate product (from stage 1) encapsulating the delicate decorative material delicate decorative material; 0.060 inch clear polymethylmethacrylate sheet (size 48 inches by 96 inches); textured release paper or plate; caul plate; and, four plies of canvas padding.

The press is preheated to a temperature of about 280° F. Then the final lay-up book is loaded into the press. The press is closed against the book at a pressure of about 40 psi. The press temperature is then ramped up until the lay-up sandwich reaches a temperature of about 290° F.-310° F. while maintaining the pressure at about 40 psi. The press is opened and all pressure is removed from the book. The press is closed against the book and the pressure is ramped up to about 160 psi. The press temperature is ramped up until the materials in the lay-up sandwich reach a temperature of about 290° F.-310° F. while maintaining the pressure at about 160 psi. This pressure and temperature is then held for about 1 to 6 minutes depending on the thickness of the lay-up sandwich to allow the polymethylmethacrylate sheets to melt together in the lay-up sandwich to provide a unitary product.

The heat is then turned off and the product is allowed to gradually cool while maintaining the pressure at about 160 psi until the product reaches a temperature of about 100° F. at which point the press is opened and the product (which may need some trimming) is removed from the press. Alternatively, product removed from the press after heating and moved into a second press having a lower temperature than the first press. The second press may then continue to apply pressure, such as at 160 psi until the product is removed. The second press may be maintained at a lower temperature than the first press by means of chilling or simply by refraining from heating the second press. Use of a second, colder press may facilitate rapid manufacturing times inasmuch as heat transfer rates are increased.

Example 2 can also be performed using polyvinyl chloride and polycarbonate, but polycarbonate requires the higher temperature of about 350° F.-375° F. Example 2 can also be performed using a combination of polymethylmethacrylate, polyvinyl chloride, or polycarbonate.

### EXAMPLE 3

This is an example of the second embodiment of the invention illustrated by FIG. 4. In this example, the basic lay-up sandwich consists of three layers of the following starting materials: (1) a bottom layer 22 of the preferred polymethylmethacrylate material that is 0.060 inch thick, 48 inches wide, and 96 inches long; (2) a pre-textured intermediate layer 24 of the preferred polymethylmethacrylate material that is 0.060 inch thick, 48 inches wide, and 96 inches long; and, (3) a top layer 26 of the preferred polymethylmethacrylate that is 0.060 inch thick, 48 inches wide, and 96 inches long. When making this product (which does not have a layer of decorative material), it is necessary to pre-texture both surfaces of the intermediate polymethylmethacrylate sheet 24 to allow air and gases to escape during the pressing/heating operation. If the surfaces of the polymethylmethacrylate sheet 24 is not pre-textured, air bubbles will be trapped within the product.

In stage 1, an intermediate lay-up book is made consisting of the following sequence from top to bottom: (1) four plies of canvas padding; caul plate; (2) textured release paper or plate providing 0.005 inch relief; (3) 0.060 inch clear or colored polymethylmethacrylate sheet (size 48 inches by 96 inches); (4) textured release paper or plate providing 0.005 inch relief; caul plate; and, (5) four plies of canvas padding.

The press is heated to about 280° F., the intermediate lay-up book is placed in the press, and the press is closed. The pressure is brought to 40 psi. When the lay-up reaches about 290° F., the pressure is increased to 160 psi and held for 1 minute. The intermediate product is then gradually cooled to 100° F.

In stage 2, the final lay-up book is made consisting of the following sequence from top to bottom: (1) four plies of canvas padding; (2) caul plate; (3) textured release paper or plate; (4) 0.060 inch clear polymethylmethacrylate sheet (size 48 inches by 96 inches); (5) 0.060 inch textured intermediate product (from stage 1); (6) 0.060 inch clear polymethylmethacrylate sheet (size 48 inches by 96 inches); (7) textured release paper or plate; (8) caul plate; and, (9) four plies of canvas padding.

The press is preheated to a temperature of about 280° F. Then the final lay-up book is loaded into the press. The press is closed against the book at a pressure of about 40 psi. The press temperature is then ramped up until the lay-up sandwich reaches a temperature of about 290° F.-310° F. while maintaining the pressure at about 40 psi. The press is opened and all pressure is removed from the book. The press is closed against the book and the pressure is ramped up to about 160 psi. The press temperature is ramped up until the materials in the lay-up sandwich reach a temperature of about 290° F.-310° F. while maintaining the pressure at about 160 psi. This pressure and temperature is then held for about 1 to 6 minutes depending on the thickness of the lay-up sandwich to allow the polymethylmethacrylate sheets to melt together in the lay-up sandwich to provide a unitary product.

The heat is then turned off and the product is allowed to gradually cool while maintaining the pressure at about 160 psi until the product reaches a temperature of about 100° F. at which point the press is opened and the product is removed from the press. The product has a stratum of the textured material permanently fixated in the matrix and co-extensive with the edges of the matrix. The flat product may be subjected to conventional thermoforming/shaping processes if a non-flat shape is desired.

This Example 3 can also be performed using polyvinyl chloride and polycarbonate, but polycarbonate requires the higher temperature of about 350° F.-375° F. Example 3 can also be performed using a combination of polymethylmethacrylate, polyvinyl chloride, or polycarbonate.

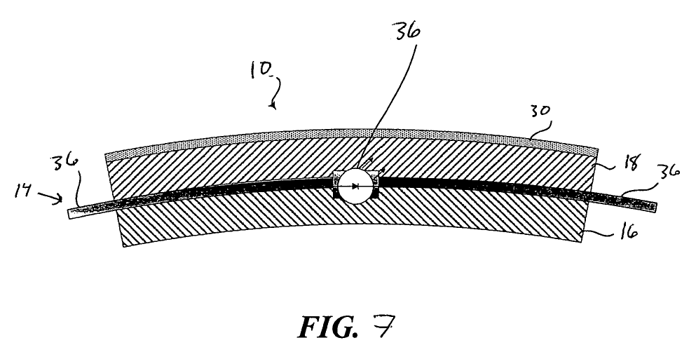

Referring to FIGS. 6 and 7, the methods described above may be used to produce a variety of products capable of functional as well as decorative uses. The polymeric layers 16 and 18 may be curved to form complex shapes or containers, such as sink bowls, bathtubs, column wraps, or countertops with integrated features such as sinks or soap trays.

The polymeric layers 16 and 18 may be curved prior to bonding to one another and the decorative materials 14. Alternatively, the press used to perform the above methods may be contoured such that the layers 16 and 18 are in the form of sheets that are bonded to one another and shaped simultaneously. In yet another embodiment, the product of the above methods may be subsequently processed into a contoured shape, such as by application of heat and pressure within a contoured press.

Referring specifically to FIG. 6, a film 30 may be applied to an outer surface of one of the polymeric sheets 16 and 18. The film 30 may provide a dry-erase writing surface, in which case the film 30 may be formed of polyethylene terephthalate (PET). In other embodiments, the film 30 provides a reflective surface for a projector. In such embodiments, the film 30 may be embodied as a vinyl film pigmented with titanium dioxide, a layer of fine glass beads, a reflective metal surface, or other reflective coating.

In other embodiments, the film 30 is an antimicrobial polymers preventing growth of bacteria, molds, and fungi. For example, MICROBAN™ polymer manufactured by the Microban Products Company™ may be used. An antimicrobial polymer may coat solid surface structures 10 forming children's chairs, changing tables, and countertops or any area where accumulation of microbes is a concern.

The film 30 may also provide chemical or ultraviolet resistance. Suitable materials for such films include polyester, Polyvinyl floride (PVF), Ethylene/trifluoro ethylene known as ETFE, fluorinated ethylene propylene known as FEP, polyvinylidene floride (PVDF), chlorotrifluoro ethylene (CTFE), or acrylic resin film such as polymethyl methacrylate, as well as various polymer extruded products.

Typically, such films have a higher melt point than the fusion point of thermoplastic used for the polymeric sheets 16, 18. Because the fusion temperature of such films is high enough to melt the thermoplastics allowing the thermoplastic to flow out of the pressure fixture, the fixation of the film 30 to the polymeric sheets 16, 18 requires interposing a heat activated adhesive coating to be applied to the film prior to bonding to most plastic substrates. Generally, the film's thickness ranges from 0.004 inch (0.100 mm) to 0.020 inch (0.500 mm).

The film 30 may also be abrasion resistant. Abrasion resistant materials include those having heat, ultraviolet or electron beam cured material deposited on a film of polyvinyl chloride PETG copolyester, polyethylene terephthalate, polymethyl methacrylate or polycarbonate. In addition, the abrasion resistance coating can be achieved with a heat cured silicone, polyurethane or fluorinated polyurethane or an ultraviolet or electron beam cured material selected from modified acrylates containing polyurethane, fluorinated polyurethane, silicone, epoxy, polyester, polyether or caprolactone residues.

The decorative object layer 14 of the laminate may also have operative properties. For example, the decorative object layer 14 may be embodied as a photoluminescent sheet 32 or distribution 32 of discrete pieces of photo-luminescent materials. In still other embodiments, the layer 14 may be embodied as a sheet 32 or distribution 32 of particles formed of ferromagnetic materials such that the solid surface structure 10 functions as a magnetic bulletin board in addition to a dry-erase board. The sheet 32 may also be formed of a fire retardant or resistant material. In other embodiments, the sheet 32 made of a honeycomb core, or perforated core material in order to reduce the weight of the solid surface structure 10.

The sheet 32 or distribution 32 may be textured or patterned, extend beyond the edges of the polymeric layers 16 and 18, or be otherwise adapted to facilitate release of gases as described above. For example, grooves or cut-outs in the sheet 32 may extend from proximate within the polymeric layers 16 and 18 to the edges thereof.

Referring to FIG. 7, in some embodiments, the decorative layer 14 may be an electrical element 34 or elements 34, such as an LED, electro luminescent material, animated display, an electro mechanical device, such as a clock or fluid pump. In such embodiments, conductive paths 36 may extend from the electrical element to the edge of the polymeric layers 16 and 18 to enable current flow to the electrical element 34. The extension of the conductive paths 36 beyond the polymeric layers 16 and 18 may facilitate ventilation during manufacture according to the manufacturing methods described above. Alternatively, the LEDs or electro luminescent material may be textured or be formed in a pattern facilitating ventilation. For example, grooves or cut-outs may extend from proximate the middle of the polymeric layers 16 and 18 toward the edges thereof.

Referring to FIG. 8, the methods described above may be used to manufacture bullet resistant glass having a decorative appearance or possessing the functionality described above. In one embodiment, a laminate includes a first outer layer 36, a first decorative layer 38, a first adhesive layer 40, a structural layer 42, a second adhesive layer 44, a second decorative layer 46, and a second outer layer 48.

The first and second outer layers 36, 48 may be abrasion resistant or have an abrasion resistant coating. In the illustrated embodiment, ⅛ inch polycarbonate, acrylic, or glass is used. The adhesive layers 40, 44 may adhere the first and second outer layers 36, 48 and the decorative layers 38, 48 to the structural layer 42. In the illustrated embodiment the adhesive layer is a polyurethane adhesive, which may have a thickness of 25 to 50 thousandths of an inch. The structural layer 42 may be embodied as glass, polycarbonate, or acrylic. In the illustrated embodiment, ½ inch polycarbonate is used.

The layers of the bullet-resistant laminate may be assembled to form a lay-up sandwich which is processed according to the methods described above in order to fuse the layers. For bullet-resistant laminates formed of polycarbonate, acrylic, and polyurethane adhesives, the press may be heated to a temperature of from 185 to 257° F. and apply a pressure of from 50 psi to 200 psi.

Various embodiments for the layers forming the bullet-resistant laminate may be used. For example, a single decorative layer 38, 46 may be included. Furthermore, multiple structural layers 42 secured to the laminate by additional adhesive layers 40, 44 may be included. Additional decorative layers 38, 46 may likewise be included.

The layers of the bullet-resistant laminate may be assembled to form a lay-up sandwich which is processed according to the methods described above in order to fuse the layers. For bullet-resistant laminates formed of polycarbonate, acrylic, and polyurethane adhesives, the press may be heated to a temperature of from 185 to 257° F. and apply a pressure of from 50 psi to 200 psi. Various embodiments for the layers forming the bullet-resistant laminate may be used. For example, a single decorative layer 82, 90 may be included. Furthermore, multiple structural layers 42 secured to the laminate by additional adhesive layers 40, 44 may be included. Additional decorative layers 38, 48 may likewise be included. The bullet resistant properties of the laminate of FIG. 8 and other exemplary laminates is summarized below.

| Description | Gauge | Expected Performance |
|---|---|---|
| 3/16 Polycarbonate | .390 | HPW Level II Step 10 |
| Polyurethane or other adhesive | | HPW TP0500.02 Level A Ballistics |
| Décor | | |
| 3/16 Polycarbonate Abrasion Resistant | | (.38 Special) |
| | | ASTM F1233 Class III Step 12 |
| ⅛ Polycarbonate Abrasion Resistant | .530 | HPW Level II Step 12 |
| Polyurethane or other adhesive | | HPW TP0500.02 Level A Ballistics |
| Décor | | |
| ¼ Polycarbonate | | (.38 Special) |
| Polyurethane or other adhesive | | ASTM F1233 Class III Step 15 |
| Décor | | |
| ⅛ Polycarbonate Abrasion Resistant | | |
| ⅛ Polycarbonate Abrasion Resistant | .780 | HPW Level IV Step 31 |
| Polyurethane or other adhesive | | HPW TP0500.02 Level B Ballistics |
| Décor | | |
| ½ Polycarbonate | | (9 mm) |
| Polyurethane or other adhesive | | ASTM F1233 Class IV Step 26 |
| Décor | | |
| ⅛ Polycarbonate Abrasion Resistant | | |
| ⅛ Polycarbonate Abrasion Resistant | .775 | HPW TP0500.02 Level B Ballistics |
| Polyurethane or other adhesive | | |
| Décor | | (9 mm) |
| ½ Acrylic | | UL Level I |
| Polyurethane or other adhesive | | |
| Décor | | |
| ⅛ Polycarbonate Abrasion Resistant | | |
| ⅛ Polycarbonate Abrasion Resistant | 1.05 | HPW Level V Step 42 |
| Polyurethane or other adhesive | | HPW TP0500.02 Level B Ballistics |
| Décor | | |
| ⅜ Polycarbonate | | (9 mm) |
| Polyurethane or other adhesive | | UL Level 2 |
| Décor | | |
| ⅜ Polycarbonate | | |
| Polyurethane or other adhesive | | |
| Décor | | |
| ⅛ Polycarbonate Abrasion Resistant | | |
| ⅛ Polycarbonate Abrasion Resistant | 1.30 | HPW Level V |
| Polyurethane or other adhesive | | HPW TP0500.02 Level C Ballistics |
| Décor | | |
| ½ Polycarbonate | | (.44 magnum) |
| Polyurethane or other adhesive | | ASTM F1233 Class IV Step 38 |
| Décor | | UL Level 3 |
| ½ Polycarbonate | | |
| Polyurethane or other adhesive | | |
| Décor | | |
| ⅛ Polycarbonate Abrasion Resistant | | |

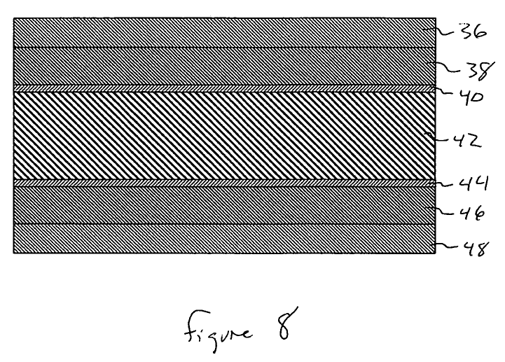

Referring to FIGS. 9A and 9B, curved structures 50 formed using the novel method disclosed hereinabove, such as the illustrated sink bowl, may include a first outer layer 52 formed of cross linked acrylic, PVC, PETG, acrylic, or polycarbonate. The first outer layer 52 may have a thickness of about 0.118 inches and may include antimicrobial additives. The first outer layer 52 is formed on a polymeric sheet 16 formed of cross-linked acrylic, PVC, PETG, acrylic, polycarbonate, or the like. The polymeric sheet 16 may have a thickness of 0.236 inches and may include an antimicrobial additive. A decorative layer 14 is positioned between the polymeric sheet 16 and includes decorative materials such as leaves, grasses, ferns, reeds, flowers, textiles, paper, printed films, metals, shells, glass, stone particles, and the like. A polymeric sheet 18 is positioned below the decorative layer 14 and is formed on of cross-linked acrylic, PVC, PETG, acrylic, polycarbonate, or the like. The polymeric sheet 18 may have a thickness of 0.236 inches and may include an antimicrobial additive. A second outer layer 54 is positioned beneath the polymeric sheet is formed of cross linked acrylic, PVC, PETG, acrylic, or polycarbonate. The second outer layer 54 may have a thickness of about 0.118 inches and may include antimicrobial additives.

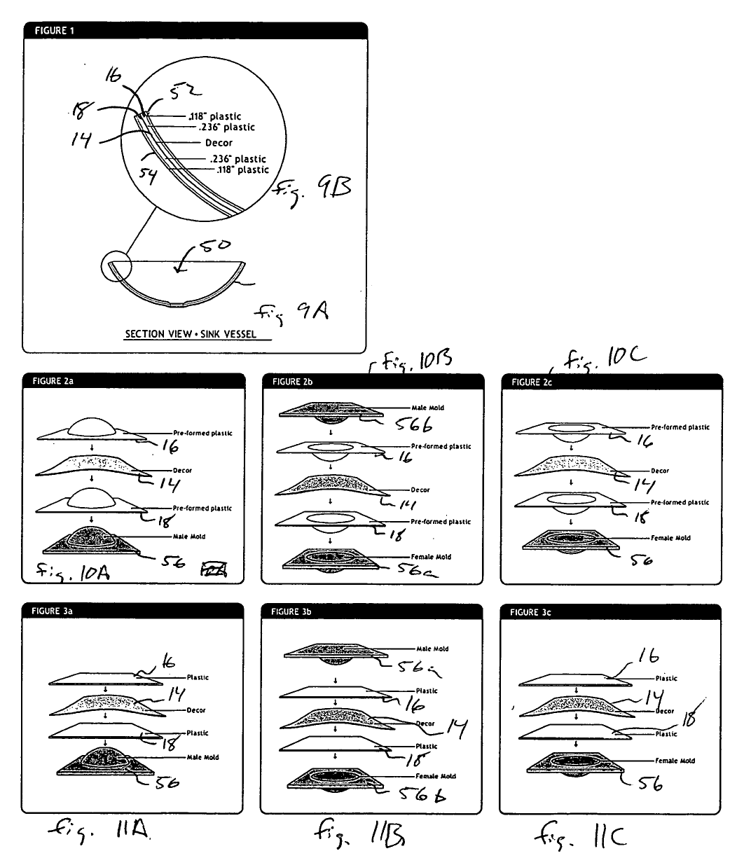

Referring to FIG. 10A, in one embodiment, a curved structure 50, such as a sink bowl, is formed using a pre-formed polymeric layers 16, 18 and a flat or otherwise unformed decorative layer 14, which may include discrete elements or a sheet. The pre-formed polymeric layers 16, 18 may be formed by standard thermoforming, vacuum forming, and other methods. The polymeric layers 16 18 and decorative layer 14 are placed over a mold 56 having the desired shape during the pressing steps discussed above. In one embodiment, the mold 56 serves as the caul plate discussed hereinabove. The mold 56 may be textured in order to emboss the laminate surface and to aid in evacuation of gasses and air during lamination. The mold 56 is typically made of wood, fiberglass, metal, epoxy, ceramic, or other suitable materials. The mold 56 is typically heated to control the heating and cooling rates of the thermoplastic and thereby reduce internal stress and shrinkage of the polymeric layers 16, 18. The assembled layers are heated under the application of pressure to fuse the polymeric layers 16, 18. Apparatus for applying heat and pressure include heated presses, vacuum forming and thermoforming machines, autoclaves and ovens in combination with vacuum blankets. The heat and time required for fusing the polymeric layers 16, 18 varies. Typical temperature ranges are 220 to 420 degrees Fahrenheit. Typical pressures are 50 to 250 psi. Typical dwell times at elevated temperature and pressure are one to 45 minutes. A thermocouple should be placed in or near the center of the laminate to ensure that the center reaches the desired lamination temperature. The laminate is typically allowed to cool to ambient temperature before relieving pressure thereon or removing the mold 56. Various alternative method for Referring to FIG. 10B, in an alternative embodiment, male and female molds 56a, 56b substantially conforming to the preformed polymeric layers 16, 18 are used. Referring to FIG. 10C, in yet another alternative embodiment, a single female mold 56 is used.

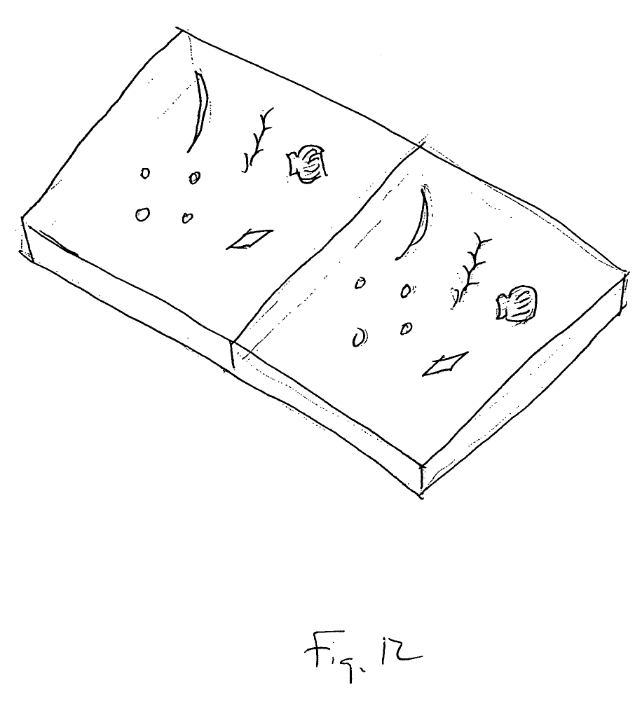

In some embodiments, the step of fusing the polymeric layers 16, 18 is performed simultaneously with the step of forming the layers 16, 18 into an alternative shape. In the embodiment of FIG. 11A unformed or planar polymeric layers 16, 18 having a decorative layer 14 positioned therebetween are pressed over single male mold 56 such as by vacuum forming, vacuum blankets or the like. Alternatively, unformed polymeric layers 16, 18 and decorative layer 14 may be formed between two molds 56a, 56b as in FIG. 11B or in a single female mold 56 as in FIG. 11C. In embodiments of the method using the molds 56, 56a, 56b of FIGS. 11A-11C, the steps of heating, pressing, and cooling, may be as in other embodiments of the method described hereinabove.

Referring to FIG. 12, the novel methods disclosed herein may be used to form various products. The novel method disclosed allows both thin and thick laminates to be formed having decorative objects encapsulated therein that are nearly as thick as the entire laminate, such as greater than the thickness of one of the polymeric layers 16, 18. The novel methods disclosed enable embedding large and small objects between polymeric layers 16, 18 having thickness from about 0.2 to 1 inch thick. The novel process also allows such relatively large objects to be positioned with precision in the laminate such that repeating patterns of discrete objects can be formed. Objects formed using the laminate disclosed herein included such products as flooring, door inserts (e.g. for cabinets, showers, entryways), bathtubs, spas, sinks, countertops, vanities, window blinds, restroom stalls, tables, chairs, appliance casings, serving trays, carts, partitions, glazing, furniture, marker boards, wall cladding, window blinds, and the like. For example, a laminate may include the following layers:
a protective urethane coating or film, which may be UV cured to cause cross-linking and may incorporate Aluminum Oxide (AlOₓ) to retard wear. The protective urethane coasting or film may be applied following formation according to the novel methods disclosed hereinabove or be included as a layer in the lay-up sandwich loaded into the press. Other protective films and hard coatings such as PVF, coated polyester, and Urethane can be used on the laminate surface to enhance performance and aesthetics. The protective urethane coating may be textured to improve appearance or gripping ability of the uppermost surface of the laminate.
a polymeric layer 16 formed as a translucent layer, whether clear or colored, formed of acrylic (such as cross-linked acrylic), PETG, PVC, or Polycarbonate, which in typical embodiments has a thickness of 0.01 to 0.1 inches, depending on the décor materials used and desired performance. The upper surface of the polymeric layer 16 may be textured. The polymeric layer 16 may be formed of cross linked acrylic for improved chemical resistance. The polymeric layers 16 may also include MICRO-BAN to inhibit microbial growth.
a decorative layer 14 including décor material such as leaves, grasses, ferns, reeds, flowers, textiles, paper, printed, films, metals, shells, glass and stone particles, and the like.
a polymeric layer 18 formed as a translucent layer, whether clear or colored, or opaque, formed of acrylic, PETG, PVC, or Polycarbonate, which in typical embodiments has a thickness of 0.01 to 0.1 inches, depending on the décor materials used and desired performance. The lowermost layer may also be formed of a fabric or other backing material promoting adhesion to a substrate. Alternatively, the bottom surface of the lowermost layer may be textured to promote adhesion to a substrate. In some embodiments the lowermost layer has a decorative background formed in, or secured to, one side thereof to be visible through the laminate. The decorative background may also serve to obscure view of the substrate. The polymeric layer 18 may be formed of cross linked acrylic for improved chemical resistance. The polymeric layers 18 may also include MICRO-BAN to inhibit microbial growth.
   The layers listed above may be repeated in order to vary the appearance of the laminate. For example, multiple décor layers separated from one another by translucent layers may be included. The laminate may further include multiple translucent layers without intervening decorative layers. For example, in one embodiment, a laminate includes a first and second translucent layers, a decorative layer, and third, fourth, and fifth translucent layers. In another embodiment, a laminate includes a first translucent layer, a first decorative layer, a second translucent layer, a second decorative layer, and a third translucent layer. The multiple translucent layers typically have thicknesses between 0.01 and 0.1 inches. The translucent layers may be formed similarly to the polymeric layers 16, 18 discussed hereinabove. Electroluminescent and photoluminescent materials and electrical devices such as LEDs may also be embedded in the laminate.

Various thermoplastic materials may be used for the polymeric sheets 16 and 18 in the various embodiments described hereinabove. For example, acrylic resins such as Polymethyl Methacrylate, known as PHMA, Polycarbonate, Polyvinyl Chloride, Polyethylene in either of high density polyethylene and low density polyethylene, Polypropylene, Polyester, Nylon and Polyurethane, Polystyrene, Fluoropolymers, Acrylonitrile-Butadiene-Styrene (ABS). Acrylic polymers may include combined cross linked and standard acrylic or 100 percent cross linked acrylic. Combination plastics, such as CPVC, ABS/Polycarbonate, ABS/PVC, Polycarbonate/Acrylic, or PVC/Acrylic. Biodegradable thermoplastics such as polylactic acid (PLA) and cellulosics such as ethyl cellulose, cellulose acetate, cellulose acetate butyrate, cellulose acetate propioniate, and cellulose nitrate serve may also be suitable.

While the preferred embodiments of the invention have been illustrated and described, it will be appreciated that various changes can be made therein without departing from the spirit and scope of the invention.

The embodiments of the invention in which an exclusive property or privilege is: claimed are defined as follows:

1. A method for manufacturing a solid surface structure comprising the steps of:
providing a first layer made of a polymeric material;
placing a decorative object on the first non-porous layer, wherein the decorative object extends beyond at least one edge of said first layer of polymeric material;
placing a second layer of polymeric material on top of the decorative object, whereby a lay-up sandwich is formed comprised of said first layer of polymeric material, an decorative object extending beyond at least one edge of both of the layers of polymeric material, and the second layer;
loading the lay-up sandwich into a press;
applying heat and pressure to the lay-up sandwich for a period of time; and
allowing the product to cool while maintaining pressure on the product.

2. The method of claim 1, wherein the decorative object comprises at least one of fabric, paper, plastic film, plastic sheet, metallic wire, rod, mesh, bar, wood veneer, dried natural materials, tree bark, plant leaves, petals, and twigs.

3. The method claim 2, wherein the decorative object comprise at least one of glass beads, glass particles and gems.

4. The method of claim 1, wherein the decorative object comprises:
one or more LEDs; and
conductive paths coupling the one or more LEDs to one another and to a point proximate a perimeter of the matrix.

5. The method of claim 1, wherein the decorative object comprises ferromagnetic material.

6. The method of claim 5, wherein the ferromagnetic material is formed in a sheet.

7. The method of claim 5, wherein the ferromagnetic material is formed in discrete particles.

8. The method of claim 1, wherein the decorative object comprises a photo-luminescent material.

9. The method of claim 1, wherein the decorative object comprises electro-luminescent material.

10. The method of claim 1, further comprising texturing the outer surface of at least one of the first and second layers.

11. The method of claim 10, wherein texturing the outer surface comprises placing textured release paper between at least one of the first and second layers and the press.

12. The method of claim 1, further comprising forming shaping the product.

13. The method of claim 1, wherein at least one of the first and second layers is formed of a cross-linked acrylic.

14. A solid surface structure comprising:
a matrix generally made of a polymeric material;
an operative structure permanently fixated in the matrix; and
a coating providing a dry-erase writing surface.

15. The solid surface structure of claim 14, wherein the coating comprises PET.

16. The solid surface structure of claim 15, wherein the operative structure is a ferromagnetic material.

17. The solid surface structure of claim 16, wherein the ferromagnetic material is formed in a sheet.

18. The solid surface structure of claim 16, wherein the ferromagnetic material is formed into multiple discrete parts.

19. The solid surface structure of claim 14, wherein the operative structure comprises photo luminescent material.

20. The solid surface structure of claim 14, wherein the operative structure comprises an electro luminescent material.

21. The solid surface structure of claim 14, wherein the operative structure comprises multiple ornamental structures.

22. The solid surface structure of claim 21, wherein the multiple ornamental structures comprise plant matter.

23. The solid surface structure of claim 21, wherein the multiple ornamental structures comprise at least one of glass beads, glass particles, and gems.

24. The solid surface structure of claim 14, wherein the operative structure comprises:
one or more LEDs; and
conductive paths coupling the one or more LEDs to one another and to a point proximate a perimeter of the matrix.

25. A method for using a solid surface structure comprising:
providing a sheet made of a polymeric material placing a decorative material on said first sheet of polymeric material;
placing a second sheet made of a polymeric material on top of said decorative material, whereby a lay-up sandwich is formed comprised of said first sheet of polymeric material, said decorative material, and said second sheet of polymeric material;
loading the lay-up sandwich into a press, the press being configured to form the lay-up sandwich according to at least one caul plate;
closing the press and applying a predetermined amount of heat and pressure to said lay-up sandwich for a predetermined period of time whereby said first and second polymeric material sheets melt together in the lay-up sandwich to provide a product;
allowing the product to cool while maintaining the pressure at a predetermined level until the product reaches a predetermined temperature at which point the press is opened and the product is removed from the press; and
forming dry-erase writing surface on at least one of the first and second nonporous sheets.

26. A solid surface structure comprising:
a matrix generally made of a polymeric material; and
an operative structure permanently fixated in the matrix; and
a screen surface coating for receiving projected images.

27. The solid surface structure of claim 26, wherein the operative structure comprises multiple ornamental structures.

28. The solid surface structure of claim 27, wherein the multiple ornamental structures comprise plant matter.

29. The solid surface structure of claim 27, wherein the multiple ornamental structures comprise at least one of glass beads, glass particles, gems, and shells.

30. The solid surface structure of claim 27, wherein the multiple ornamental structures comprise shells.

31. A method for manufacturing a solid surface structure comprising the steps of:
providing a first layer made of a polymeric material;
providing a second layer made of polymeric material;
placing a decorative object between the first and second layers, the first and second non porous sheets and decorative object forming a lay-up sandwich, the decorative object extending beyond at least one edge of the first sheet of polymeric material;
loading the lay-up sandwich into a press; and
applying heat and pressure to the lay-up sandwich for a period of time.

32. The method of claim 31, further comprising forming the first and second layers into an arcuate shape.

33. The method of claim 32, wherein forming the first and second layers into an arcuate shape occurs prior to loading the lay-up sandwich into the press.

34. The method of claim 32, wherein the press comprises arcuate top and bottom plates and wherein forming the first and second layers into an arcuate shape occurs substantially simultaneously with application of heat and pressure to the lay-up sandwich.

35. The method of claim 32, wherein the arcuate shape is a sink bowl.

36. The method of claim 32, wherein the decorative object comprises at least one of fabric, paper, plastic film, plastic sheet, metallic wire, rod, mesh, bar, wood veneer, dried natural materials, tree bark, plant leaves, petals, and twigs.

37. The method claim 32, wherein the decorative object comprise at least one of glass beads, glass particles and gems.

38. The method of claim 32, wherein the decorative object comprises:
one or more LEDs; and
conductive paths coupling the one or more LEDs to one another and to a point proximate a perimeter of the matrix.

39. The method of claim 32, wherein the decorative object comprises a photo luminescent material.

40. The method of claim 32, wherein the decorative object comprises electro luminescent material.

41. The method of claim 32, further comprising texturing the outer surface of at least one of the first and second layers.

42. The method of claim 41, wherein texturing the outer surface comprises placing textured release paper between at least one of the first and second layers and the press.

43. The method of claim 31, further comprising forming the product into a counter top.
